(19) United States
(12) Patent Application Publication
(10) Pub. No.: US 2012/0111225 A1
(43) Pub. Date: May 10, 2012

(54) OIL-BASED INKJET INK

(75) Inventors: Kenji YAMADA, Ibaraki-ken (JP); Akiko YAMAMOTO, Ibaraki-ken (JP)

(73) Assignee: RISO KAGAKU CORPORATION, Tokyo (JP)

(21) Appl. No.: 13/288,735

(22) Filed: Nov. 3, 2011

(30) Foreign Application Priority Data
Nov. 9, 2010 (JP) 250415/2010

(51) Int. Cl. C09D 11/06

(52) U.S. Cl. 106/31.9; 106/31.6

(57) ABSTRACT

An oil-based inkjet ink contains at least a pigment and an organic solvent, wherein the pigment includes an anionic group in an amount ranging from 1.5 to 10 μeq/m², and the content of the pigment in the ink is 15 mass % or more relative to the total amount of the ink.

### BACKGROUND OF THE INVENTION

1. Field of the Invention

The present invention relates to an oil-based inkjet ink that is suitable for use with an inkjet recording system, and more particularly to an oil-based inkjet ink that can reduce or eliminate striking through while ensuring high image density.

2. Description of the Related Art

Inkjet recording systems eject a highly fluid inkjet ink from very thin head nozzles as ink particles to record an image on a sheet of printing paper, which is positioned to face the nozzles . Because of low noise and ability of high-speed printing, the inkjet recording systems are rapidly becoming widely used in recent years . As an ink for use with the inkjet recording systems, an oil-based inkjet ink, which is formed by finely dispersing a pigment in a non-water-soluble solvent, is known.

The oil-based inkjet ink typically uses a pigment dispersant to ensure dispersion stability of the pigment. Therefore, after the ink has been transferred onto a sheet of printing paper, the pigment tends to penetrate into the paper when a solvent in the ink penetrates into the printing paper. For this reason, use of the oil-based inkjet ink tends to result in lower image density and more striking through than those in the case where a water-based inkjet ink is used. In order to increase the printing density, it may be considered to increase the ratio of the pigment in the ink. For example, Japanese Unexamined Patent Publication Nos. 2003-261808 and 2004-002666 teach that the pigment content in the ink may be up to 20 mass % relative to the total amount of the ink.

However, while dot density increases as the pigment content is increased, leveling of the ink decreases and this results in a smaller dot area. Therefore, under a low resolution printing condition, such as 600 dpi, gaps are formed between the dots and this results in even lower image density. The problem of lowering of the image density due to the formation of gaps between the dots is more notable under a printing condition of an even lower resolution, such as 300 dpi or less, or under a printing condition using a line system where an image is formed in a single pass. Further, in the case where the pigment content in the ink is actually higher than 10 mass %, the ink has a high viscosity, and this tends to make it difficult to eject the ink from the inkjet head.

### SUMMARY OF THE INVENTION

In view of the above-described circumstances, the present invention is directed to providing an oil-based inkjet ink that can reduce or eliminate striking through while ensuring high image density.

An aspect of the oil-based inkjet ink of the invention is an oil-based inkjet ink containing at least a pigment and an organic solvent, wherein the pigment includes an anionic group in an amount ranging from 1.5 to 10 μeq/m², and the content of the pigment in the ink is 15 mass % or more relative to the total amount of the ink.

The pigment may be a carbon black.

The anionic group may be —COOH or —SO₃H.

The organic solvent may contain an organic solvent having a 50% distillation point of 150° C. or more and a viscosity of 5 mPa·s or less in an amount of 75 mass % or more relative to the total amount of the organic solvent.

In the case where the ink contains a pigment dispersant, the content of the pigment dispersant may be not more than 30 mass % relative to the pigment.

Since the oil-based inkjet ink of the invention contains at least a pigment and an organic solvent, wherein the pigment includes an anionic group in an amount ranging from 1.5 to 10 μeq/m², and the content of the pigment in the ink is 15 mass % or more relative to the total amount of the ink, the oil-based inkjet ink of the invention can reduce or eliminate striking through while ensuring high image density.

### DESCRIPTION OF THE PREFERRED EMBODIMENTS

An oil-based inkjet ink (which may hereinafter be referred simply to as “ink”) of the invention is an oil-based inkjet ink containing at least a pigment and an organic solvent, wherein the pigment includes an anionic group in an amount ranging from 1.5 to 10 (μeq/m²), and the content of the pigment in the ink is 15 mass % or more relative to the total amount of the ink.

A preferred example of the pigment is a carbon black. In the following description, the carbon black is used as an example of the pigment. Examples of the carbon black may include furnace black, channel black, lamp black and pine carbon black. Among them, furnace black is more preferred. The carbon black has a mean primary particle size in the range from 10 to 50 nm or preferably in the range from 10 to 40 nm, and preferably has a specific surface area (according to JIS K6217) in the range from 50 to 150 m²/g and a pH in the range from 5 to 9.

An anionic group is added to the carbon black in the invention. In general, commercially available carbon blacks contain about 1 μeq/m² of an anionic group, such as hydroxyl group, carboxyl group, or the like. The carbon black used in the invention includes the anionic group in an amount of 1.5 μeq/m² or more by further addition of the anionic group. If the anionic group content is less than 1.5 μeq/m², it is impossible to sufficiently increase image density. The anionic group content may more preferably be 1.7 μeq/m² or more.

Although the upper limit of the anionic group content is not particularly specified, it is difficult in view of production to provide an anionic group content more than 10 μeq/m², and it is also difficult to increase the image density proportionally to the increase of the anionic group content if the anionic group content exceeds 10 μeq/m². In view of balance between increase of the image density and the anionic group content, the anionic group content may preferably be 8.0 μeq/m² or less, or more preferably be 6.0 μeq/m² or less. The above-specified anionic group content is relative to the entire carbon black. A mixture of a carbon black with an anionic group content less than the lower limit value and a carbon black with an anionic group content more than the upper limit value may be used.

Examples of the anionic group may include —COOM, —SO₃M, —OSO₃M, and PO (OM) ₂ (where M is a hydrogen atom or an alkyl metal ion). Among them, —COOH or —SO₃H is preferred. These anionic groups may be used singly or in combination, as appropriate. The anionic group may be directly bound to the carbon black or may be bound to the carbon black via some group. The bonding pattern may be any pattern, such as covalent bond or ionic bond, as long as the anionic group is not dissociated by the organic solvent.

The addition of the anionic group to the carbon black can be achieved by reacting the carbon black with a radical generator while heating and stirring them in a water-based solvent under an inert gas. The heating temperature is preferably 40° C. or more, or more preferably in the range from 50 to 80° C. Alternatively, the addition of the anionic group may be achieved by an oxidation treatment with hot air, ozone, nitric acid, NO₂, H₂O₂, cool plasma, or the like. During reaction, it is preferred to add a dispersant, such as an anionic surfactant, to disperse the carbon black. Further, a crushing medium, such as zirconia beads, may be used to achieve stirring. After the reaction, the reaction product is separated by centrifugation, and the solid content is washed with water or alcohol, and then is filtered and dried.

Examples of the radical generator may include a radical polymerization initiator, a peroxide, etc. Preferred examples of the radical generator may include potassium persulfate represented by the formula below:

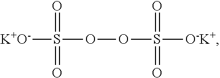

sodium persulfate, ammonium persulfate and superphosphates. Persulfates and superphosphates can also act as an oxidizing agent, and therefore a carboxyl group can be added by conducting an oxidation treatment. Selection between the radical reaction and the oxidation reaction can be achieved by controlling the reaction temperature.

The content of the pigment in the ink is 15 mass % or more, preferably 20 mass % or more, or more preferably 25 mass % or more relative to the total amount of the ink. If the pigment content is less than 15 mass %, it is difficult to obtain an image with sufficient density. On the other hand, an excessively high pigment content results in an excessively high viscosity of the ink. In view of this, the pigment content is preferably not more than 30 mass %. With respect to conventional inks, if the pigment content exceeds 10 mass %, leveling of the ink decreases and this results in a smaller dot area. Therefore, under a low-resolution printing condition, gaps are formed between the dots and this rather decreases the image density. In contrast, the pigment in the ink of the invention includes the anionic group in an amount ranging from 1.5 to 10 (μeq/m²), and this allows increase of the image density. The mechanism of action is not exactly clear. However, while it is estimated that a pigment with an anionic group added thereto is not suitable for use with a non-water-based ink from the fact that inkjet printing paper (coated paper) often has an anionic surface, the ink of the invention can surprisingly form a high density image without causing agglomeration of the pigment, etc.

Further, since the pigment content in the ink of the invention is as high as 15 mass % or more relative to the total amount of the ink, the ratio of the organic solvent is low as a result, and thus penetration of the solvent into the printing paper relatively decreases, thereby reducing the striking through. Further, pigment dispersants in general have high affinity for a solvent and a pigment . Therefore, the pigment in the ink tends to penetrates into the printing paper when the solvent penetrates into the printing paper. In view of reducing or eliminating the striking through, it is preferred that the content of the pigment dispersant is small. The pigment of the ink of the invention includes the anionic group in an amount ranging from 1.5 to 10 (μeq/m²), and this prevents agglomeration of the pigment in the ink. Therefore, the content of the pigment dispersant can be reduced, thereby allowing reduction or elimination of the striking through.

The organic solvent used in the ink of the invention preferably contains an organic solvent having a 50% distillation point of 150° C. or more and a viscosity of 5 mPa·s or less (which may hereinafter be referred to as “specific organic solvent”) in an amount of 75 mass % or more relative to the total amount of the organic solvent. The 50% distillation point refers to a temperature at which 50% by mass of the solvent is volatilized, which is measured according to JIS K0066 “Test Methods for Distillation of Chemical Products”. The ink of the invention containing the organic solvent which contains 75 mass % or more of the specific organic solvent can achieve high ejection stability even if the ink has a high pigment content.

Preferred examples of the specific organic solvent may include hydrocarbon, ester, and propylene carbonate. Preferred examples of the hydrocarbon may include naphthene-based solvents, such as Exxol D40 and Exxol D80 (which are available from Exxon), and AF-4 (available from Nippon Oil Corporation), and isoparaffin-based solvents, such as Isopar H, Isopar L and Isopar M (which are available from Exxon). Preferred examples of fatty acid ester may include fatty acid ester-based solvents, such as palm fatty acid methyl and methyl laurate (which are available from Kao Corporation). The specific organic solvent may be used singly or in mixture of two or more species, as appropriate.

The pigment dispersant, which may be used in the ink of the invention, may be any of various pigment dispersants. Examples of the pigment dispersant may include a hydroxyl group-containing carboxylic acid ester, a salt of a long-chain polyamino-amide and a high molecular weight acid ester, a salt of a high molecular weight polycarboxylic acid, a salt of a long-chain polyamino-amide and a polar acid ester, a high molecular weight unsaturated acid ester, modified polyurethane, modified polyacrylate, a polyether ester-based anionic activator, naphthalenesulfonate-formalin condensate salt, polyoxyethylene alkyl phosphate, polyoxyethylene nonylphenyl ether, polyester polyamine and stearylamine acetate.

Among them, polymer-based dispersants are preferred, and examples thereof may include those available under the following trade names: SOLSPERSE 5000 (phthalocyanine ammonium salt-based), 11200 (polyamide-based), 13940 (polyester amine-based), 17000, 18000 (fatty acid amine-based), 22000, 24000 and 28000 (which are available from Lubrizol Japan Limited); EFKA 400, 401, 402, 403, 450, 451, 453 (modified polyacrylate), 46, 47, 48, 49, 4010 and 4055 (modified polyurethane) (which are available from Efka CHEMICALS); DEMOL P, EP, POIZ 520, 521, 530 and HOMOGENOL L-18 (polycarboxylic acid-based polymeric surfactant) (which are available from Kao Corporation); DISPARLON KS-860 and KS-873N4 (amine salt of polymeric polyester) (which are available from Kusumoto Chemicals, Ltd.); DISCOL 202, 206, OA-202 and OA-600 (multi-chain polymeric non-ionic) (which are available from Dai-Ichi Kogyo Seiyaku Co., Ltd.); and ANTARON V216 (vinylpyrrolidone-hexadecene copolymer) (available from ISP Japan Ltd.) Among them, polyamide-based dispersants and vinylpyrrolidone-hexadecene copolymer are more preferred.

The content of the dispersant is preferably not more than 80 mass %, more preferably not more than 60 mass %, even more preferably not more than 40 mass %, and particularly preferably not more than 30 mass % relative to the pigment. Dispersants in general have high viscosity. Therefore, if the dispersant content exceeds 80 mass %, the resulting viscosity of the ink is excessively high and this is not preferred. As described above, the pigment of the ink of the invention includes the anionic group in an amount ranging from 1.5 to 10 (μeq/m²), and this prevents agglomeration of the pigment in the ink. Therefore, the ink of the invention may contain no pigment dispersant.

It should be noted that, although the carbon black is used as an example of the pigment in the above description, any of conventionally known inorganic pigments and organic pigments may be used as appropriate in the ink of the invention. Examples of the inorganic pigments may include titanium oxide, colcothar, cobalt blue, ultramarine, iron blue, carbon black, calcium carbonate, kaolin, clay, barium sulfate, talc and silica. Examples of the organic pigments may include insoluble azo pigment, azo lake pigment, condensed azo pigment, condensed polycyclic pigment and copper phthalocyanine pigment. These pigments may be used singly or in mixture of two or more species, as appropriate.

Besides the above-described components, the ink of the invention may contain conventionally used additives. Examples of the additives may include a surfactant, such as an anionic, cationic, amphoteric or non-ionic surfactant, and an antioxidizing agent, such as dibutylhydroxytoluene, propyl gallate, tocopherol, butylhydroxyanisole or nordihydroguaiaretic acid.

The ink of the invention can be prepared, for example, by putting all the components at once or in fractions in a known dispersing device, such as a bead mill, to disperse the components, and filtering them with a known filtering device, such as a membrane filter, as desired.

Examples of the oil-based inkjet ink of the invention are described below.

### EXAMPLES

### Treatment of Carbon Black

Materials according to each formulation shown in Table 1 were measured and put in a flask provided with a stirrer, a thermometer, a nitrogen gas introduction device and a cooling tube. In the materials shown in Table 1, the carbon black is MA600 (with an anionic group content of 1.07 μeq/m², a particle size of 20 nm, a specific surface area of 140 m²/g (JIS K6217) and pH=7) available from Mitsubishi Chemical Corporation, KPS is potassium per sulfate represented by the formula shown above (available from Wako Pure Chemical Industries, Ltd.), and DEMOL NL is β-naphthalenesulfonate-formalin condensate sodium salt (available from Kao Corporation).

Then, zirconia beads (2.0 mmφ, 450 g/100 g of reaction mixture) were measured and put in the above flask, and nitrogen gas was injected while stirring to substitute the atmosphere in the flask with the nitrogen gas . The flask was set in an oil bath set at a predetermined reaction temperature (50° C. for a pigment 1, 100° C. for a pigment 2 and 50° C. for a pigment 3), and the mixture in the flask were stirred at 100 rpm under the nitrogen gas atmosphere to react the mixture for six hours for the pigment 1 and the pigment 2, and for three hours for the pigment 3.

The resulting reaction mixture was filtered to remove the beads, and then, BUTYCENOL (tetraethylene glycol monobutyl ether available from Kyowa Hakko Chemical Co., Ltd.) of equal mass was added to the remaining reaction mixture and the mixture was stirred. Thereafter, the content of the flask was separated by centrifugation into a solid content and a liquid content . The separated solid content was dispersed in water and stirred for 12 hours at 70° C., and the unreacted surface treating agent was dissolved in methanol (water may be used). Then, the solid content was filtered with a filter to isolate the carbon black. The resulting carbon black was dried for 12 hours at 100° C.

Table 1 shows formulations together with properties. The anionic group contents in the pigments 1 to 3 were measured as follows .

A value obtained by conducting a titration test of 20 ml of a decinormal aqueous solution of sodium hydrogen carbonate with a centinormal aqueous solution of hydrochloric acid was used as a blank titer . Then, 1 g of the dried carbon black for each of the pigments 1 to 3 was weighed in milligrams in a conical flask, and 50 ml of a decinormal aqueous solution of sodium hydrogen carbonate was added. The flask was shaken for four hours and then the content of the flask was filtered. Then, 20 ml of the supernatant liquid of the resulting filtrate was collected, and a value obtained by conducting a titration test with a centinormal aqueous solution of hydrochloric acid was used as a titer of each pigment to find the anionic group content on the surface . This value was divided by a nitrogen adsorbed specific surface area of the untreated carbon black (MA600 in the Examples), and a resulting value was used as the anionic group content per unit area (μeq/m²).

Anionic group content (μeq/m²)=[{(50/20)×0.01×(titer-nil titer)}/(mass×specific surface area of untreated carbon black)]×10³

TABLE 1

| | | Pigment 1 | | Pigment 2 | | Pigment 3 | |
|---|---|---|---|---|---|---|---|
| Carbon black | | 10 | g | 10 | g | 10 | g |
| Surface | KPS | 1 | g | 1 | g | 1 | g |
| treating agent | | | | | | | |
| Pigment | DEMOL NL | 2 | g | 2 | g | 2 | g |
| dispersant | | | | | | | |
| Solvent | Water | 70 | g | 100 | g | 70 | g |
| | Ethanol | 30 | g | 0 | g | 30 | g |

| Temperature (° C.) | | 50 | 100 | 50 |
|---|---|---|---|---|
| Anionic group | Species | COOH | COOH + SO₃H | COOH |
| | Content | 5.35 | 2.14 | 1.8 |
| | (μeq/m²) | | | |

### Preparation of Ink

Materials according to each composition shown in Table 2 below (the numerical values shown in Table 2 are in parts by mass) were premixed, and then were dispersed with a rocking mill for one hour. Then, coarse particles were removed with using a 0.8-μm membrane filter to prepare ink samples of Examples 1 to 9 and Comparative Example 1.

### Imaging

Image samples were taken under the following printing conditions.

Head: CB2 head (available from Toshiba Tec Corporation)
Resolution: 300 dpi×300 dpi
Image: black monochromatic solid image
Amount of droplet per dot: 30 pL
Printing paper: RISO paper (thin type) (available from Riso Kagaku Corporation)

### Evaluation

### Evaluation of Image Density

The above image samples were left for one day in an environment of RT of 23° C. and RH of 50%, and image density of each sample was evaluated according to the following criteria with using the image sample of Comparative Example 1 as the reference (evaluation of which was Bad).
Acceptable: increase of image density relative to the reference (Bad) was observed.
Good: marked increase of image density relative to the reference (Bad) was observed.

### Evaluation of Striking Through

The above image samples were left for one day in an environment of RT of 23° C. and RH of 50%, and striking through of each sample was evaluated according to the following criteria with using the image sample of Comparative Example 1 as the reference (evaluation of which was Bad).
Acceptable: reduction of striking through relative to the reference (Bad) was observed.
Good: marked reduction of striking through relative to the reference (Bad) was observed.

TABLE 2

| | | | | | | | | | | Comp. |
|---|---|---|---|---|---|---|---|---|---|---|
| | | Ex- | Ex- | Ex- | Ex- | Ex- | Ex- | Ex- | Ex- | Ex- |
| | | ample | ample | ample | ample | ample | ample | ample | ample | ample |
| | | 1 | 2 | 3 | 4 | 5 | 6 | 7 | 8 | 1 |
| Pigment | MA600 | | | | | | | | | 8 |
| | Pigment 1 | 15 | | 15 | | | | | | |
| | Pigment 2 | | 15 | | | | | | | |
| | Pigment 3 | | | | 15 | 25 | 25 | 25 | 25 | |
| Pigment | S11200 | 15 | 15 | | 15 | 25 | 20 | 15 | 30 | 8 |
| dispersant | (solid content 50%) | | | | | | | | | |
| | (available from | | | | | | | | | |
| | Lubrizol) | | | | | | | | | |
| Organic | AF-4 (available from JX | 60 | 60 | | 60 | | | | | 30 |
| solvent | Nippon Oil & Energy | | | | | | | | | |
| | Corporation) | | | | | | | | | |
| | Exxol D80 (available | | | | | 50 | 55 | 60 | 45 | |
| | from Exxon) | | | | | | | | | |
| | IOP (available from | 10 | 10 | | 10 | | | | | 54 |
| | Kao Corporation) | | | | | | | | | |
| | Propylene carbonate | | | 85 | | | | | | |
| | (available from | | | | | | | | | |
| | Wako Pure Chemical | | | | | | | | | |
| | Industries, Ltd.) | | | | | | | | | |
| Total | | 100 | 100 | 100 | 100 | 100 | 100 | 100 | 100 | 100 |
| Amount of specific organic solvent | | 60 | 60 | 85 | 60 | 50 | 50 | 50 | 50 | 30 |
| Total amount of organic solvent | | 70 | 70 | 85 | 70 | 50 | 50 | 50 | 50 | 84 |
| Ratio of specific organic solvent (%) | | 86 | 86 | 100 | 86 | 100 | 100 | 100 | 100 | 36 |
| Ratio of pigment dispersant (solid content) | | 50 | 50 | 0 | 50 | 50 | 40 | 30 | 60 | 50 |
| to pigment (mass %) | | | | | | | | | | |
| Evaluation | Image density | Good | Good | Good | Good | Good | Good | Good | Good | Reference |
| | | | | | | | | | | (Bad) |
| | Striking through | Acceptable | Acceptable | Good | Acceptable | Good | Good | Good | Good | Reference |
| | | | | | | | | | | (Bad) |
| | Viscosity of ink (mPas/s) | 13 | 13 | 14 | 13 | 41 | 25 | 17 | 66 | 14 |

As shown in Table 2, when compared to the ink of Comparative Example 1 which uses a conventional carbon black, the ink of the invention was able to provide sufficient image density that matched the pigment content even when the pigment content was high, and was able to reduce or eliminate the striking through. Further, with the ink samples of Examples 5 to 8 which had a higher pigment content, ejection stability was ensured even with higher ink viscosity. Moreover, since the ink of the invention has the high anionic group content, the ink can be produced without adding a pigment dispersant, as shown in Example 3, by controlling the content of the specific organic solvent, thereby reducing or eliminating the striking through due to the pigment dispersant.

What is claimed is:

1. An oil-based inkjet ink comprising:
at least a pigment and an organic solvent, wherein the pigment comprises an anionic group in an amount ranging from 1.5 to 10 μeq/m², and a content of the pigment in the ink is 15 mass % or more relative to a total amount of the ink.

2. The oil-based inkjet ink as claimed in claim 1, wherein the pigment comprises a carbon black.

3. The oil-based inkjet ink as claimed in claim 1, wherein the anionic group is —COOH or —SO₃H.

4. The oil-based inkjet ink as claimed in claim 2, wherein the anionic group is —COOH or —SO₃H.

5. The oil-based inkjet ink as claimed in claim 1, wherein the organic solvent comprises an organic solvent having a 50% distillation point of 150° C. or more and a viscosity of 5 mPa·s or less in an amount of 75 mass % or more relative to a total amount of the organic solvent.

6. The oil-based inkjet ink as claimed in claim 2, wherein the organic solvent comprises an organic solvent having a 50% distillation point of 150° C. or more and a viscosity of 5 mPa·s or less in an amount of 75 mass % or more relative to a total amount of the organic solvent.

7. The oil-based inkjet ink as claimed in claim 3, wherein the organic solvent comprises an organic solvent having a 50% distillation point of 150° C. or more and a viscosity of 5 mPa·s or less in an amount of 75 mass % or more relative to a total amount of the organic solvent.

8. The oil-based inkjet ink as claimed in claim 4, wherein the organic solvent comprises an organic solvent having a 50% distillation point of 150° C. or more and a viscosity of 5 mPa·s or less in an amount of 75 mass % or more relative to a total amount of the organic solvent.

9. The oil-based inkjet ink as claimed in claim 1, further comprising a pigment dispersant, wherein a content of the pigment dispersant is not more than 30 mass % relative to the pigment.

10. The oil-based inkjet ink as claimed in claim 2, further comprising a pigment dispersant, wherein a content of the pigment dispersant is not more than 30 mass % relative to the pigment.

11. The oil-based inkjet ink as claimed in claim 3, further comprising a pigment dispersant, wherein a content of the pigment dispersant is not more than 30 mass % relative to the pigment.

12. The oil-based inkjet ink as claimed in claim 4, further comprising a pigment dispersant, wherein a content of the pigment dispersant is not more than 30 mass % relative to the pigment.

13. The oil-based inkjet ink as claimed in claim 5, further comprising a pigment dispersant, wherein a content of the pigment dispersant is not more than 30 mass % relative to the pigment.

14. The oil-based inkjet ink as claimed in claim 6, further comprising a pigment dispersant, wherein a content of the pigment dispersant is not more than 30 mass % relative to the pigment.

15. The oil-based inkjet ink as claimed in claim 7, further comprising a pigment dispersant, wherein a content of the pigment dispersant is not more than 30 mass % relative to the pigment.

16. The oil-based inkjet ink as claimed in claim 8, further comprising a pigment dispersant, wherein a content of the pigment dispersant is not more than 30 mass % relative to the pigment.
